(19) United States
(12) Patent Application Publication
(10) Pub. No.: US 2025/0131333 A1
(43) Pub. Date: Apr. 24, 2025

(54) SYSTEM AND METHOD FOR SAAS DATA CONTROL PLATFORM

(71) Applicant: ROYAL BANK OF CANADA, Toronto (CA)

(72) Inventors: Salah SHARIEH, Toronto (CA); Fatima Javaid HUSSAIN, Toronto (CA); Evgenii OSTANIN, Toronto (CA); Brett NOYE, Toronto (CA); Paula DUZI, Toronto (CA); Haoyue BAI, Toronto (CA); Nebojsa DJOSIC, Toronto (CA)

(73) Assignee: ROYAL BANK OF CANADA, Toronto (CA)

(21) Appl. No.: 18/920,869

(22) Filed: Oct. 19, 2024

Related U.S. Application Data
(60) Provisional application No. 63/591,560, filed on Oct. 19, 2023.
(60) Provisional application No. 63/591,549, filed on Oct. 19, 2023.
(60) Provisional application No. 63/591,566, filed on Oct. 19, 2023.
(60) Provisional application No. 63/591,646, filed on Oct. 19, 2023.
(60) Provisional application No. 63/591,690, filed on Oct. 19, 2023.
(60) Provisional application No. 63/655,183, filed on Jun. 3, 2024.

(51) Int. Cl. G06N 20/00; G06F 40/40

(52) U.S. Cl. CPC G06N 20/00; G06F 40/40

(57) ABSTRACT

There is provided a system for performing compliance and risk assessment of a software application, such as a Software-as-a-Service (SaaS) application. The system may store historical compliance evidence data and receive updated compliance evidence data. The system may include a plurality of machine learning models which are trained using different subsets of historical compliance evidence data. When received updated compliance evidence data is incomplete, the machine learning models may be used to generate predicted compliance evidence so as to provide a full compliance evidence data set. One or more of risk and/or compliance scores may be determined based on combinations of received compliance data, predicted compliance data, and historical compliance data.

### CROSS-REFERENCE TO RELATED APPLICATIONS

This claims priority to and the benefit of U.S. Provisional Patent Application No. 63/591,549, filed Oct. 19, 2023, U.S. Provisional Patent Application No. 63/591,560, filed Oct. 19, 2023, U.S. Provisional Patent Application No. 63/591,566, filed Oct. 19, 2023, U.S. Provisional Patent Application No. 63/591,646, filed Oct. 19, 2023, U.S. Provisional Patent Application No. 63/591,690, filed Oct. 19, 2023, and U.S. Provisional Patent Application No. 63/655,183, filed Jun. 3, 2024, the entire contents of each of the above-identified applications being incorporated herein by reference.

### FIELD

This relates generally to computerized systems for use with Software-as-a-Service applications.

### BACKGROUND

The use of computerized systems and software has become ubiquitous throughout organizations. In many organizations, the use of third party Software-as-a-Service (SaaS) applications (i.e. SaaS applications which are created and administered outside of the organizing using the SaaS) is becoming increasingly common, as modern communications systems have overcome bandwidth limitations which might have limited the utility of such SaaS applications in the past. Moreover, an increasing number of vendors have shifted to only offering SaaS distribution models.

However, there are a number of challenges inherent with the use of third party SaaS applications for organizations. For example, an organization may be subject to regulations and/or compliance requirements to which the organization is required to adhere. When computer and/or software systems are developed and implemented within an organization, such systems may be tailored to the particular regulations and/or compliance requirements to which the organization is bound. However, third party SaaS applications may not have been developed with a particular set of regulations or compliance requirements in mind, particularly given that compliance requirements might vary from customer to customer, and as such there might not be a uniform set of standards for to which a particular SaaS application must adhere.

For many organizations, adherence to regulatory and compliance requirements is of paramount importance, and ensuring that any proposed new SaaS is compliant with regulations and/or compliance requirements may be a time-consuming and onerous task, which may prevent, impede or retard the adoption of improved technologies and services. Moreover, ensuring that an existing SaaS application is indeed compliant with regulations and compliance requirements may be an onerous and time-consuming task, and compliance verification may be conducted infrequently as a result. Failure to adequately monitor such operation may introduce threats to an organization, both from the perspective of the risk of non-compliance, and to system security.

Conventional systems which analyze compliance data typically create events and send alerts for individual events. However, the nature of complex compliance monitoring systems is such that many variables are changing at all times, and that a change in a single variable may have a lead to a distorted sense of risk or alert when it is not warranted.

Accordingly, there is a need for a computing system which ensures that third party SaaS applications are operating as intended and in compliance with regulations and compliance requirements. There is also a need for a computing system which can adapt to changing conditions and predict potential risks in an accurate manner.

### SUMMARY

According to an aspect, there is provided a method of performing risk and compliance evaluations, the method comprising: receiving, at a compliance evidence data receiver, a set of compliance evidence data; transforming, by a parsing and formatting module, said set of compliance evidence data to a standardized format; storing said standardized set of compliance evidence data in a compliance data store; determining that said standardized set of compliance evidence data is incomplete; training a plurality of machine learning models based on historical sets of compliance evidence data, wherein each of said plurality of machine learning models is trained using a distinct subset of said historical set of compliance evidence data; generating, by said plurality of machine learning models, predicted compliance evidence data, wherein said predicted compliance evidence data combined with said standardized set of compliance evidence data forms a complete set of compliance evidence data; determining, based on a score analyzer, one or more of compliance and risk scores for a set of data comprising said standardized set of compliance evidence data and said predicted compliance evidence data; and presenting said compliance and risk scores to one or more users.

According to another aspect, there is provided a system for performing risk and compliance evaluations, the system comprising: one or more processors; and a non-transitory computer-readable storage medium having stored thereon processor-executable instructions that, when executed by said one or more processors, cause said one or more processors to perform a method comprising: receiving, at a compliance evidence data receiver, a set of compliance evidence data; transforming, by a parsing and formatting module, said set of compliance evidence data to a standardized format; storing said standardized set of compliance evidence data in a compliance data store; determining that said standardized set of compliance evidence data is incomplete; training a plurality of machine learning models based on historical sets of compliance evidence data, wherein each of said plurality of machine learning models is trained using a distinct subset of said historical set of compliance evidence data; generating, by said plurality of machine learning models, predicted compliance evidence data, wherein said predicted compliance evidence data combined with said standardized set of compliance evidence data forms a complete set of compliance evidence data; determining, based on a score analyzer, one or more of compliance and risk scores for a set of data comprising said standardized set of compliance evidence data and said predicted compliance evidence data; and presenting said compliance and risk scores to one or more users.

According to still another aspect, there is provided a non-transitory computer-readable storage medium having stored thereon processor-executable instructions that, when executed by one or more processors, cause said one or more processors to perform a method comprising: receiving, at a compliance evidence data receiver, a set of compliance evidence data; transforming, by a parsing and formatting module, said set of compliance evidence data to a standardized format; storing said standardized set of compliance evidence data in a compliance data store; determining that said standardized set of compliance evidence data is incomplete; training a plurality of machine learning models based on historical sets of compliance evidence data, wherein each of said plurality of machine learning models is trained using a distinct subset of said historical set of compliance evidence data; generating, by said plurality of machine learning models, predicted compliance evidence data, wherein said predicted compliance evidence data combined with said standardized set of compliance evidence data forms a complete set of compliance evidence data; determining, based on a score analyzer, one or more of compliance and risk scores for a set of data comprising said standardized set of compliance evidence data and said predicted compliance evidence data; and presenting said compliance and risk scores to one or more users.

Other features will become apparent from the drawings in conjunction with the following description.

### BRIEF DESCRIPTION OF DRAWINGS

In the figures which illustrate example embodiments,

FIG. 1 is a block diagram depicting components of an example computing system;

FIG. 2 is a block diagram depicting components of an example computing device;

FIG. 3 depicts a simplified arrangement of software at a computing device;

FIG. 4 is a block diagram depicting an example process of receiving a set of compliance evidence; and

FIG. 5 depicts an example process of creating and training machine learning models for use in predicting compliance evidence data when received compliance evidence data is incomplete.

### DETAILED DESCRIPTION

At present a given organization may use dozens or even hundreds of Software-as-a-Service (SaaS) solutions across various lines of business, and which have varying degrees of complexity (e.g. some may use confidential data, others may use sensitive data, still others may use restricted data, and the like). Such SaaS applications may be executing on different cloud platforms, although many SaaS applications may be concentrated within a few large cloud providers (e.g. AWS).

When an organization decides whether to make use of a new SaaS solution, an organization must determine whether the SaaS solution is compliant with regulatory and compliance requirements, and this may be difficult to determine in an expedient manner. In particular, there are many different approaches to assessing regulatory compliance and risk (e.g. Supplier Risk Management Assessments (SRMA), Shared SaaS Responsibility Assessments (SSRA), Supplier Controls Assessments (SCA), and the like), many of which are questionnaire-based and require inputs from both users and suppliers to make an assessment. Completion of such assessments can be quite time-consuming, which limits the ability for SaaS solutions to be adopted in a timely manner, and which may pose significant inconvenience internally within an organization.

As described herein, some embodiments may provide data-driven automation for SaaS applications which facilitates processing of compliance evidences and continuous real-time risk assessment. Some embodiments may facilitate automation of onboarding processes for SaaS applications to ensure that a SaaS application is compliant from the beginning, and/or to reduce the amount of time required to certify a SaaS application as compliant. Some embodiments may allow for automation of compliance assessments for SaaS applications which run on computing platforms which are external to an organization's network (e.g. SaaS applications running on public and/or third-party cloud computing platforms, such as Amazon Web Services (AWS)). In some embodiments, systems disclosed herein may facilitate identification of dependences and patterns which exist between a plurality of SaaS applications (e.g. dependencies which may exist between SaaS applications relating to customer relationship management, business process management, human resource management, and the like).

In some embodiments, systems and methods disclosed herein may allow for one or more of: SaaS applications being adopted and onboarded faster than traditional methods, resulting in reduction of the time required to implement a new SaaS application, a reduction in the cost of onboarding an SaaS application, a reduction in the costs associated with regulatory compliance for a given SaaS application, a reduction in the cost of governance and management associated with a given SaaS application, real-time access to risk and compliance data relating to an SaaS, more accurate risk and compliance data, the ability to demonstrate alignment/compliance with regulatory requirements, and/or the ability to more quickly recognize which SaaS applications require further attention and/or scrutiny.

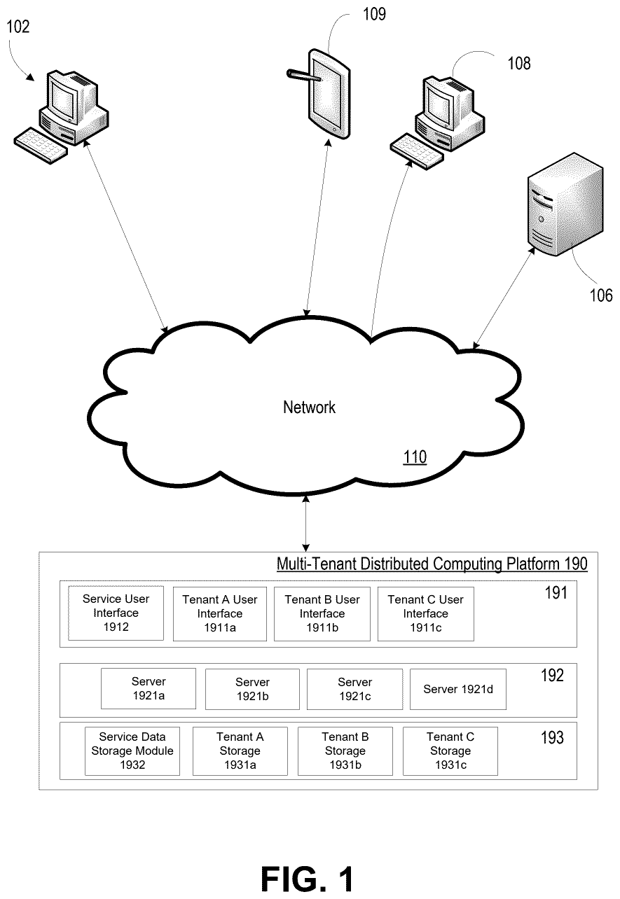

Various embodiments of the present invention may make use of interconnected computer networks and components. FIG. 1 is a block diagram depicting components of an example multi-tenant operating environment. Components of the computing system are interconnected to define a compliance and risk assessment system. As used herein, the term “compliance and risk assessment system” refers to a combination of hardware devices configured under control of software and interconnections between such devices and software. Such systems may be operated by one or more users or operated autonomously or semi-autonomously once initialized.

As depicted, the operating environment includes a variety of clients incorporating and/or incorporated into a variety of computing devices which may communicate with a distributed computing platform 190 via one or more networks 110. For example, a client may incorporate and/or be incorporated into client application implemented at least in part by one or more computing devices. Example computing devices may include, for example, at least one server 102 with a data storage 104 such as a hard drive, array of hard drives, network-accessible storage, or the like; at least one web server 106, and a plurality of client computing devices 108. Server 102, web server 106, and client computing devices 108 may be in communication by way of a network 110. More or fewer of each device are possible relative to the example configuration depicted in FIG. 1.

Network 110 may include one or more local-area networks or wide-area networks, such as IPv4, IPv6, X.25, IPX compliant, or similar networks, including one or more wired or wireless access points. The networks may include one or more local-area networks (LANs) or wide-area networks (WANs), such as the internet. In some embodiments, the networks are connected with other communications networks, such as GSM/GPRS/3G/4G/LTE/5G networks.

In some embodiments, the distributed computing platform 190 may provide access to one or more software applications, such as Software-as-a-Service (SaaS) applications to one or more users or “tenants”. As depicted, distributing computing platform 190 may include multiple processing layers, including a user interface layer 191, an application server layer 192, and a data storage layer 193.

In some embodiments, the user interface layer 191 may include a user interface (e.g. service UI 1912) for the platform 190 to provide access to applications and data for a user (or “tenant”) of the service, as well as one or more user interfaces 1911a, 1911b, 1911c, which may be specialized in accordance with specific tenant requirements which may be accessed via one or more Application Programming Interfaces (APIs). It will be appreciated that each processing layer may be implemented using a plurality of computing devices and/or components as described below, and may perform various operations and functions to implement, for example, a SaaS application. In the some embodiments, the data storage layer 193 may include, for example, a data storage module for the service, as well as one or more tenant data storage modules 1931a, 1931b, 1931c which may contain tenant-specific data which is used in providing tenant-specific services or functions.

In some embodiments, platform 190 may be operated by an entity (e.g. Amazon, Microsoft, Google, or the like) in order to provide multiple tenants with applications, data storage, and functionality. A multi-tenant system as depicted in FIG. 1 may include multiple different applications (e.g. multiple different SaaS applications) and data stores, and may be hosted on a distributed computing system which includes multiple servers 1921a, 1921b, 1921c. In some embodiments, the server(s) 1921a, 1921b, 1921c and the services they provide are referred to as the host, and remote computers external to platform 190 and the software applications executing thereon are referred to as clients.

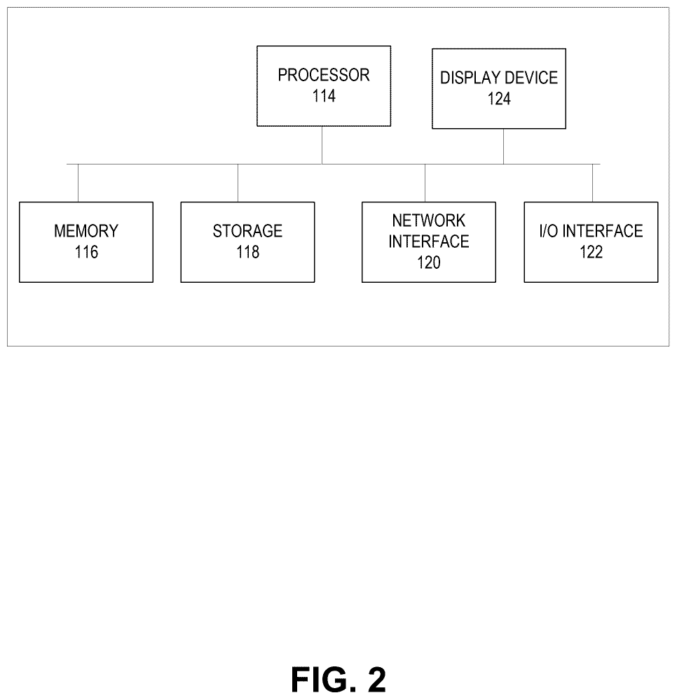

FIG. 2 is a block diagram depicting components of an example computing device, such as a desktop computing device 102, server 1921, client computing device 108, tablet 109, mobile computing device, and the like. As depicted, an example computing device may include a processor 114, memory 116, persistent storage 118, network interface 120, and input/output interface 122.

Processor 114 may be an Intel or AMD x86 or x64, PowerPC, ARM processor, or the like. Processor 114 may operate under the control of software loaded in memory 116. Network interface 120 connects the computing device to network 110. Network interface 120 may support domain-specific networking protocols for certain peripherals or hardware elements. I/O interface 122 connects the computing device to one or more storage devices and peripherals such as keyboards, mice, pointing devices, USB devices, disc drives, display devices 124, and the like.

In some embodiments, I/O interface 122 may connect various hardware and software devices used in connection with the operation of third party SaaS applications (e.g. SaaS applications hosted by platform 190) to processor 114 and/or to other computing devices. In some embodiments, I/O interface 122 may be compatible with protocols such as WiFi, Bluetooth, and other communication protocols.

Software may be loaded onto one or more computing devices. Such software may be executed using processor 114.

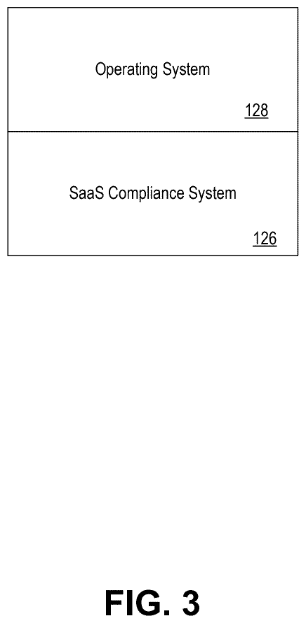

FIG. 3 depicts a simplified arrangement of software at an example computing device. The software may include an operating system 128 and application software, such as SaaS compliance system 126. It will be appreciated that in distributed computing environments, implementation and administration of an application such as a SaaS application or a SaaS compliance system 126 may be distributed amongst a plurality of separate computing devices, and FIG. 3 is intended to depict a simplified logical separation between an operating system and an application executing thereon on an example computing device.

In an example compliance system, compliance controls are used to monitor and collect compliance evidence 275 from applications running in cloud operating environments. For example, specific cloud environment (e.g. Amazon Web Services (AWS)) compliance controls may be implemented by a SaaS application and the cloud provider (e.g. AWS) and may generate compliance evidence 275 based on controls. In some embodiments, compliance evidence 275 may be stored in a data repository, such as compliance data store 1050. An example system for generating compliance evidence is disclosed in U.S. Provisional Patent Application No. 63/691,549, filed Oct. 19, 2023, the entire contents of which are incorporated herein by reference.

As described herein, some embodiments of system 126 collect, process and store compliance evidence 275. In some embodiments, as further described below, a prediction engine 260 may increase the accuracy of real-time, continuous compliance assessments by making predictions based on partial real-time compliance evidence data 275 processing and various historical data sets. Some embodiments may continually improve the performance and value of predictions by using a novel approach to ensemble techniques for training machine learning (ML) models which run in parallel.

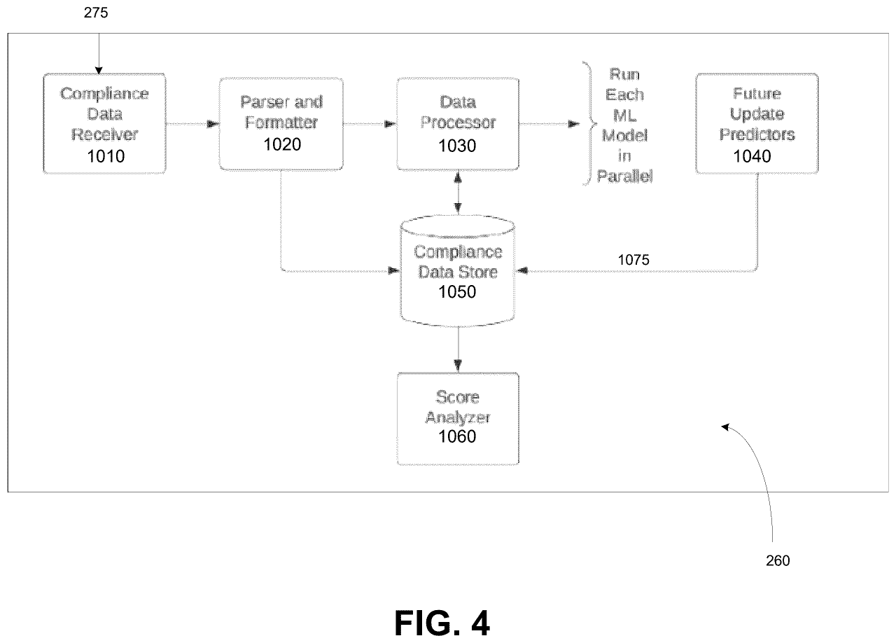

FIG. 4 is a block diagram depicting an example process of receiving a set of compliance evidence data 275 using prediction engine 260. As depicted, example prediction engine 260 includes compliance data receiver 1010, parser and formatter 1020, data processor 1030, compliance data store 1050, future update predictors 1040, and score analyzer 1060.

In some embodiments, compliance data receiver 1010 may receive a set of partial compliance evidence 275 via real-time event processing. In some embodiments, partial compliance evidence data 275 may be specific to a particular application (e.g. a SaaS application), though in other embodiments the data may not be application-specific.

Prediction engine 260 may be configured to process partial compliance evidence 275 using data processor 1030. Prediction engine may be further configured to update and store compliance data 275 in compliance data store 1050. Prediction engine 260 may be further configured to generate one or more of compliance scores and/or risk scores which indicate the degree to which the evaluated application, entity or group is compliant with regulatory requirements.

As depicted in FIG. 4, prediction engine 260 further includes an update predictor module 1040 which generates predictions for expected future updates (whether in the form of additional compliance evidence 275, changes to controls, or the like) which have not yet been received by engine 260.

In some embodiments, update predictor module 1040 comprises a plurality of prediction engines. In some embodiments, prediction engines may be running in parallel. In some embodiments, prediction engines may be ML models which have been trained based on historical data.

In some embodiments, the historical data may be for a particular application, although in other embodiments the historical data might not be application-specific. In some embodiments, ML models may be based on both historical data for an application and historical data for the application provider of that application (e.g. if the particular application is one of several applications from the same developer). In some embodiments, ML models may be further trained using other available data and system configurations. It will be appreciated that there is a vast number of variables and data which can be used for training ML models. The exact type of data may depend on the type of application (e.g. SaaS), the cloud provider, the type of integration, the users, and the like. One of the advantages associated with some embodiments described herein is that the system is not limited to static or known variables, and has the capability to adapt to unknown, dynamically changing data and data types. As merely an example, additional data may include data generated during periodic disaster recovery testing, combined with a schedule for such disaster recovery testing, and/or maintenance schedules, durations of outages by type of error, and the like.

In some embodiments, the predictions generated by update predictor module 1040 may be used to generate additional sets of compliance scores and/or risk scores based on a combination of real compliance evidence 275 (that is, compliance evidence 275 which was actually received) and predicted compliance evidence 1075 (that is, compliance evidence which has been predicted but not occurred or been received). In some embodiments, predicted compliance evidence 1075 may be stored in compliance data store 1050 along with real compliance evidence 275.

In some embodiments, data processor 1030 is configured to perform compliance assessments based on both real 275 and predicted evidence 1075, which are then used as inputs into a plurality of ML models which can be used to create long-term analysis and assessments which may be used for subsequent decision-making. In some embodiments, prediction engine 260 may include a monitoring and feedback loop, which may enable prediction engine 260 to continuously learn through optimization of predictions over time.

In some embodiments, all output scores (i.e. compliance and risk scores produced with and without predictions) may be collected, stored, and presented to users and stakeholders. This may provide stakeholders with a detail-rich picture with high granularity of the continuously changing compliance and risk landscape for their systems. Such a system may be said to be proactive rather than reactive, as it may allow an organization to proactively make adjustments in anticipation of a potential future event, rather than waiting for a potentially negative event to occur and reacting only when it is too late.

As will be appreciated by those skilled in the art, models which are used for risk and compliance evidence 275 processing and assessment may be multi-variate, multi-dimensional, complex, and non-linear systems with relationships which are complex and difficult to model using traditional linear methods. As such, models typically do not respond in a linear manner to a change in rules or conditions. For example, if an input is increased by an amount or multiplied by an amount, the output from a system will likely not be scaled up by that amount or multiplied by that amount.

Likewise, in a real-time compliance monitoring system, compliance evidence data 275 may be continuously received in a stream of events, but will typically not involve a full set of evidence data 275. For example, in a system using a model which incorporates 5 weighted predictors (e.g. for which the sum of the weights is equal to 1), a given event is unlikely to yield compliance evidence 275 relating to all 5 predictors. Instead, such evidence 275 is likely to relate to one or more predictors but less than all of the predictors, and as such may be referred to as partial compliance evidence.

The presence of partial compliance evidence 275 may significantly impact the performance of the system, given that as noted above, such systems are non-linear. As such, the continuous processing of partial evidence 275 may produce continuous, non-linear fluctuations. Such behaviour may be difficult to analyze, as it may appear to be random, unpredictable, and difficult to comprehend. Such fluctuations might not only reduce the performance of the system, but may also cast doubt on the utility of such systems to stakeholders. Some embodiments described herein may ameliorate the performance and reliability of the outputs of the system by using predicted compliance evidence 1075 in combination with observed compliance evidence 275. Such a combination may result in the compliance evidence data used by the system being reliable while avoiding the fluctuations in output which might be caused by the use of only partial real compliance evidence 275 which omits one or more predictors.

Some embodiments implement a novel approach to machine learning which is based on ensemble learning (typically characterized by combining multiple base ML models). However, traditional ensemble learning techniques are not appropriate for compliance testing contexts. In situations of high-dimensionality and high complexity, it is unlikely that any ML model would be sufficient to continuously provide the desired level of ML model performance. Moreover, using a single, more complex ML model would be likely to degrade run-time performance of the system, as well as simply being difficult to develop and maintain in a real-life scenario. Additionally, developing a fully automated feedback loop to optimize training and deployment of a complex monolithic system would be problematic due to the potential degradation issues in real-time performance resulting from even minor changes. In accordance with some embodiments, the diversity and complementary strengths of different ML models may be leveraged through the use of novel ensembles to improve generalization, reduce overfitting, and enhance prediction accuracy.

Some embodiments may implement an ensemble technique referred to as bootstrap aggregating (sometimes referred to as “bagging”). Bagging typically involves training multiple ML models independently using different subsets of training data. The training data may be obtained through bootstrapping (i.e. sampling with replacement). A final prediction may then be made by aggregating predictions from each individual ML model (whether through majority voting in the case of classifier models, or through averaging in the case of regression models). Notably, such techniques allow for parallel running.

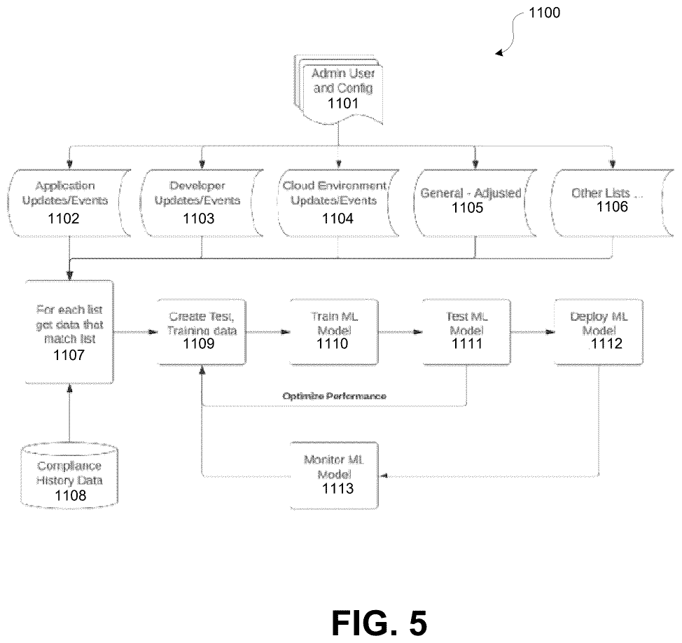

In some embodiments, prediction engine 260 uses a classification (as shown, e.g., in FIG. 5) to create separate training data sets. In some embodiments, each of such training data sets may be subjected to bagging and ensembling techniques in order to train engines for run-time processing.

Moreover, during real-time time processing (as depicted, e.g., in FIG. 4), future predictors 1040 (which may each be an ensemble) may run in parallel and store their individual results in compliance data store 1050. In contrast with conventional ensemble learning techniques (in which individual results are treated as intermediaries and discarded after the ensemble has determined the overall score), some embodiments described herein store the individual intermediary results, thereby creating the opportunity for delayed and/or multiple ensembles scores at a later time. This allows for optimization through the automation of each ensemble running in parallel (which also allows for adding, removing, changing ML engines, and for using several different overall combinations, and applying the delayed ensembling techniques at presentation time). As a result, the systems and methods disclosed herein may be easier to develop, maintain and use while offering improvements in overall performance.

Returning to FIG. 4, compliance data receiver 1010 receives a set of compliance evidence data 275. Since compliance evidence data 275 may be received from many different sources and in different formats, in some embodiments a parser and formatter 1020 may be used to normalize compliance evidence 275 into a format that the rest of the system will be able to understand and use subsequently. Normalized compliance evidence 275 may then be stored in compliance data store 1050.

In some embodiments, a system configuration may provide definitions of full sets of compliance data 275, and as such data processor 1030 can determine whether a change to compliance data store 1050 constitutes a full update or a partial update. Since the compliance evidence 275 already in data store 1050 represents the current data prior to an update, processor 1030 may determine how much, and what type, of further processing is required. Thus, In some embodiments, processing may be triggered on a relatively small portion of the full set of the compliance evidence data 275. For example, in a public cloud there may be several thousands of controls based on one or more specific configuration values, which may be used as compliance evidence 275. Thus, a change to any one configuration value could trigger an event which will be processed by the system. However, it is highly unlikely that all of the thousands of configuration settings would be changed, and as such it is preferable for processor 1030 to determine which portion will require processing, thus conserving computing resource relative to conventional systems which would process thousands of configuration settings in the compliance event payload.

In some embodiments, upon receiving a partial compliance evidence data set 275, processor 1030 may trigger a parallel run of a set of pre-trained ML engines within update predictor module 1040. In some embodiments, each of said pre-trained ML engines will predict what a full set of compliance data 275 would look based on the specific data which was used for training each ML engine and the incoming partial compliance data 275.

In some embodiments, ML engines may calculate a level of confidence in the resulting output. In some embodiments, the confidence score may be a value between 0 and 1. For example, a confidence score of 0 may mean that the ML engine was unable or failed to make a prediction, and a confidence score of 1 may mean the ML engine has full confidence and that there is no uncertainty in the predictions. It will be appreciated by those skilled in the art that a confidence score of 1 is practically impossible, unless the received compliance data 275 already constituted a full set and thus required no prediction.

After predictions have been made, compliance scores and risk scores may be calculated by each ML engine of module 1040 and stored in compliance data store 1050 together with the associated confidence levels. These results and confidence levels may then be processed by score analyzer 1060.

In some embodiments, analyzer 1060 may determine compliance scores based on aggregated sums, weighted sums, or another metric based on the individual compliance evidence 275 (including predicted compliance evidence 1075) and associated confidence values which were provided as inputs to analyzer 1060. In some embodiments, the overall determined aggregated compliance score may also have a confidence estimate associated therewith. In some embodiments, the aggregated confidence estimate may be based on the confidence scores associated with each individual compliance evidence score predicted by the system.

In some embodiments, analyzer 1060 may use all of the available data from compliance data store 1050, including both compliance and risk scores calculated based on real compliance evidence 275 and predicted compliance evidence 1075. In some embodiments, analyzer 1060 may report the results of aggregation an the overall compliance and risk scores to a user interface for presentation to a user.

FIG. 5 depicts an example process 1100 of creating and training ML models 1040. In some embodiments, training ML models 1040 may be based on historical compliance evidence 275 data and configuration. One of the goals of the process 1100 is to create trained ML models based on different subsets from the full population of all compliance evidence data 275. In some embodiments, datasets may be created to include historical compliance evidence for one or more of: each application 1102, each application developer 1103 (e.g. when more than one application from the same developer is being used), each environment 1104 (e.g. public cloud, private networks, etc.) in cases where more than one application is running in the same environment, and the like. Other examples of datasets may include clusters or classes of similar applications created based on one or more sets of features.

As depicted, once ML models 1040 are created at block 1109, they may be trained at block 1110, tested at block 1111, and deployed at block 1112. In some embodiments, models may be continuously monitored and evaluated at block 1113 as part of a feedback loop intended to improve accuracy. Given that compliance evidence data 275 is continuously received and updated, ML models 1040 similarly must be continuously trained as a consequence.

The following is an example intended to depict simplified operation of the systems and methods described herein. It will be appreciated that the actual processing in a real-world scenario would be far more complex and involve far more different scenarios.

In this example, a data feed of compliance evidence 275 may be received in real-time and, based on the configuration and expectations provided by the models trained on historical data, the engine may decide that the specific input is a partial update of a set of controls. In this example, the engine may receive updates for A and B, whereas the expected full set of controls would include A, B, C and D. The missing values for C and D will therefore be predicted as described above. The engine would then include the following three states: a) the original values for A, B, C and D which were present before the updated for A and B arrived, b) the updated values for A and B (denoted as Ax and Bx) along with unchanged values for C and D, and c) the updated values Ax and Bx, and the predicted updated values Cx and Dx. Scores may then be calculated for each of the three states as described above, which may produce actual compliance and risk scores, as well as adjusted scores which include the predicted updated values for Cx and Dx. Over time, the system is expected to learn and increase the accuracy of adjusted scores which include predictions.

Of course, the above-described embodiments are intended to be illustrative only and in no way limiting. The described embodiments are susceptible to many modifications of form, arrangement of parts, details, and order of operation. The invention is intended to encompass all such modifications within its scope, as defined by the claims.

What is claimed is:

1. A method of performing risk and compliance evaluations, the method comprising:
receiving, at a compliance evidence data receiver, a set of compliance evidence data;
transforming, by a parsing and formatting module, said set of compliance evidence data to a standardized format;
storing said standardized set of compliance evidence data in a compliance data store;
determining that said standardized set of compliance evidence data is incomplete;
training a plurality of machine learning models based on historical sets of compliance evidence data, wherein each of said plurality of machine learning models is trained using a distinct subset of said historical set of compliance evidence data;
generating, by said plurality of machine learning models, predicted compliance evidence data, wherein said predicted compliance evidence data combined with said standardized set of compliance evidence data forms a complete set of compliance evidence data;
determining, based on a score analyzer, one or more of compliance and risk scores for a set of data comprising said standardized set of compliance evidence data and said predicted compliance evidence data; and
presenting said compliance and risk scores to one or more users.

2. The method of claim 1, wherein each of said predicted compliance evidence data objects has a confidence score associated therewith.

3. The method of claim 2, wherein said compliance and risk scores are based at least in part on said confidence score associated with said predicted compliance evidence data objects.

4. The method of claim 2, wherein said confidence score is a value between 0 and 1.

5. The method of claim 1, wherein each of said plurality of machine learning models is executed in parallel.

6. A system for performing risk and compliance evaluations, the system comprising:
one or more processors; and
a non-transitory computer-readable storage medium having stored thereon processor-executable instructions that, when executed by said one or more processors, cause said one or more processors to perform a method comprising:
receiving, at a compliance evidence data receiver, a set of compliance evidence data;
transforming, by a parsing and formatting module, said set of compliance evidence data to a standardized format;
storing said standardized set of compliance evidence data in a compliance data store;
determining that said standardized set of compliance evidence data is incomplete;
training a plurality of machine learning models based on historical sets of compliance evidence data, wherein each of said plurality of machine learning models is trained using a distinct subset of said historical set of compliance evidence data;
generating, by said plurality of machine learning models, predicted compliance evidence data, wherein said predicted compliance evidence data combined with said standardized set of compliance evidence data forms a complete set of compliance evidence data;
determining, based on a score analyzer, one or more of compliance and risk scores for a set of data comprising said standardized set of compliance evidence data and said predicted compliance evidence data; and
presenting said compliance and risk scores to one or more users.

7. The system of claim 6, wherein each of said predicted compliance evidence data objects has a confidence score associated therewith.

8. The system of claim 7, wherein said compliance and risk scores are based at least in part on said confidence score associated with said predicted compliance evidence data objects.

9. The system of claim 7, wherein said confidence score is a value between 0 and 1.

10. The system of claim 6, wherein each of said plurality of machine learning models is executed in parallel.

11. A non-transitory computer-readable storage medium having stored thereon processor-executable instructions that, when executed by one or more processors, cause said one or more processors to perform a method comprising:
receiving, at a compliance evidence data receiver, a set of compliance evidence data;
transforming, by a parsing and formatting module, said set of compliance evidence data to a standardized format;
storing said standardized set of compliance evidence data in a compliance data store;
determining that said standardized set of compliance evidence data is incomplete;
training a plurality of machine learning models based on historical sets of compliance evidence data, wherein each of said plurality of machine learning models is trained using a distinct subset of said historical set of compliance evidence data;
generating, by said plurality of machine learning models, predicted compliance evidence data, wherein said predicted compliance evidence data combined with said standardized set of compliance evidence data forms a complete set of compliance evidence data;
determining, based on a score analyzer, one or more of compliance and risk scores for a set of data comprising said standardized set of compliance evidence data and said predicted compliance evidence data; and
presenting said compliance and risk scores to one or more users.

12. The computer-readable storage medium of claim 11, wherein each of said predicted compliance evidence data objects has a confidence score associated therewith.

13. The computer-readable storage medium of claim 12, wherein said compliance and risk scores are based at least in part on said confidence score associated with said predicted compliance evidence data objects.

14. The computer-readable storage medium of claim 12, wherein said confidence score is a value between 0 and 1.

15. The computer-readable storage medium of claim 11, wherein each of said plurality of machine learning models is executed in parallel.
